(19) United States
(12) Patent Application Publication
(10) Pub. No.: US 2016/0117795 A1
(43) Pub. Date: Apr. 28, 2016

(54) POINT CLOUD DATA PROCESSING SYSTEM AND METHOD THEREOF AND COMPUTER READABLE STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); SU-YING FU, Shenzhen (CN); ZONG-TAO YANG, Shenzhen (CN)

(21) Appl. No.: 14/921,048

(22) Filed: Oct. 23, 2015

(30) Foreign Application Priority Data
Oct. 27, 2014 (CN) 201410583886.7

(51) Int. Cl. G06T 1/20; G06T 15/00; G06T 7/00

(52) U.S. Cl. CPC G06T 1/20; G06T 7/0081; G06T 7/0059; G06T 15/00; G06T 2200/04; G06T 2207/10028; G06T 2207/20072; G06T 2210/12; G06T 2210/56

(57) ABSTRACT

A point cloud data processing system permitting free-form data selection of the cloud data includes an image forming module, a coordinate conversion module, a selection module, and a determination module. The image forming module graphs a three-dimensional image of the point cloud file. The coordinate conversion module transforms the three-dimensional image into a planar image. The selection module performs a polygon-shaped selection operation and shows a polygon-shaped region based a point cloud area selected in such a manner that the polygon-shaped region circumscribes the point cloud area selected. The determination module graphs a bounding box based on the outline of the polygon-shaped region, and determines whether graphical points lie inside both the bounding box and the polygon-shaped region. Graphical points that lie within both are further marked with color or other marking process, and graphical points which are not within both can be deleted or edited.

### CROSS-REFERENCE TO RELATED APPLICATIONS

This application claims priority to Chinese Patent Application No. 201410583886.7 filed on Oct. 27, 2014 in the China Intellectual Property Office, the contents of which are incorporated by reference herein.

### FIELD

The subject matter herein generally relates to a data processing, particularly related to a system and method for processing point cloud data

### BACKGROUND

A scanner in general outputs three-dimensional point cloud data for an object (e.g., a product) scanned, however, the quality of a scanned image in practice is subject to the performance or capability of scanner, luminosity, operating environment, as well as characteristics of the object scanned. As such, a scanned image often contains many undesired noises points, which causes contours in the images to be unclear, and magnifies errors in detection resulting in increasing complexity and difficulty in detection process and lowering of the detection accuracy. Moreover, it is known that without the flexibility to freely select point cloud data for processing in a point cloud data processing system, the performances of detection in images and processing will be limited, or the data processing result might not be useful in the subsequent image analysis operation. Under the current point cloud data processing system, users are only be able to use a simple object selection method or smaller area selection method (such as rectangular-shaped selection frame or rectangular-shaped area selection) during the operation of image processing. In other words, there is not yet a single method that can be used by the user to make large or small area selections, users have to go through complicate switching operations and choose different methods to select between large and small areas. Moreover, only simple geometrical shapes such as triangular or rectangular can be processed, and complex shaped or irregular shaped areas cannot not be processed.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram illustrating a point cloud data processing system as an exemplary embodiment.

FIG. 2 is a flowchart diagram illustrating a point cloud data processing method as an exemplary embodiment.

FIG. 3 is a diagrammatic view illustrating the operation of the point cloud data processing method in the exemplary embodiment.

FIG. 4 is a diagrammatic view illustrating the operation of the point cloud data processing method in the exemplary embodiment.

FIG. 5 is a diagrammatic view illustrating the operation of the point cloud data processing method in the exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The term “outside” refers to a region that is beyond the outermost contour of an area. The term “inside” indicates that at least a portion of a region is partially contained or located within a boundary formed by an area. The term “comprising” means “including, but not necessarily limited to”; it specifically indicates open-ended inclusion or membership in a so-described combination, group, series and the like.

The drawings are not necessarily to scale and the proportions of certain parts may be exaggerated to better illustrate details and features. The description is not to be considered as limiting the scope of the embodiments described herein.

The present disclosure provides a system and a method for point cloud data processing, which enables a user to accurately select any graphical point to process by enabling the user to flexibly select any region of any shape or size, quickly eliminate noise and undesired graphical points existed in the point cloud image, and produce an accurate profile image for a product.

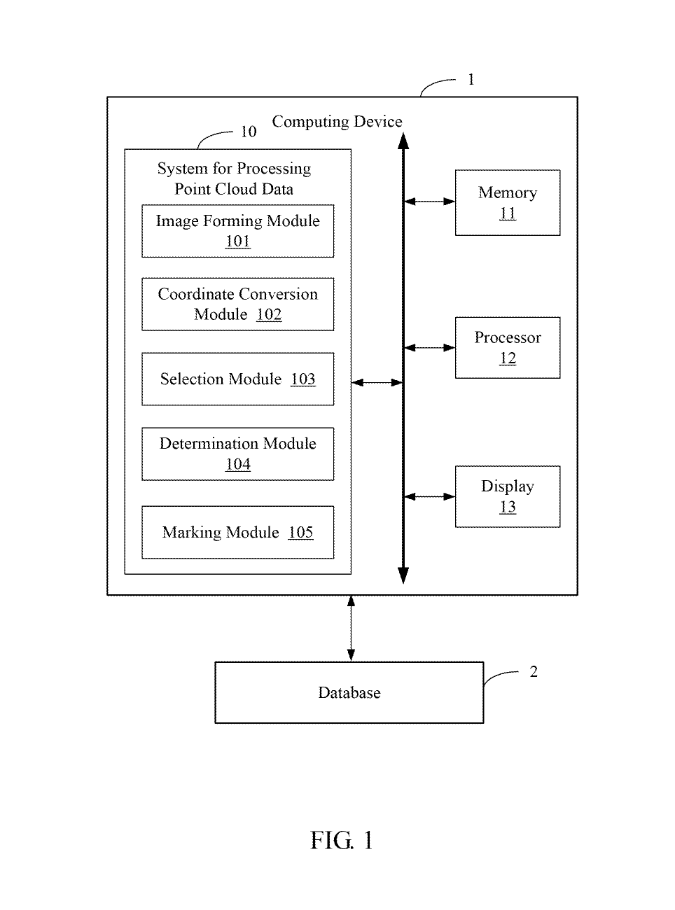

FIG. 1 shows a system for processing point cloud data. In the illustrated embodiment, a system for processing point cloud data (hereinafter “the system 10”) is installed and operated on a computing device 1. The computing device 1 includes but is not limited to a personal computer, a workstation computer, a laptop, a server, or other equivalent computing device. The computing device 1 is communicably coupled to a database 2. In at least one embodiment, the computing device 1 is linked to the database 2 via a cable or an Ethernet cable (e.g., WAN or LAN cable).

The computing device 1 in the illustrated embodiment includes a memory 11, a processor 12, and a display 13. The system 10 is communicatively coupled to the memory 11, the processor 12, and the display 13 via a data bus. The processor 12 is also communicatively coupled to the memory 11, the display 13, and the database 2 via the data bus. The computing device 1 has an operating system (e.g., Windows or Linux) and at least one application program (e.g., CAD graphic software) installed thereon.

The database 2 is configured to store at least one point cloud file corresponding to an object under analysis. The object may include but is not limited to a manufactured product (e.g., an electronic product or a component of the manufactured product). The database 2 may be implemented using any suitable hardware and/or software means.

The point cloud file is a file containing point cloud data corresponding to the object as measured in a coordinate system (e.g., a Cartesian coordinate system). Specifically, the point cloud file may contain spatial coordinate data corresponding to the object under analysis. In at least one embodiment, the point cloud data of the object may be a set of vertices in a three-dimensional (3D) coordinates system.

The point cloud file can be opened and edited via a graphic processing system (e.g., CAD graphical system). In particular, the graphic processing system is capable of interpreting and processing the point cloud data (i.e., the spatial coordinates) from the point cloud file and forming a three-dimensional (3D) point cloud image. The graphic processing system is also installed onto the computing device 1 and may be implemented or initiated by an image processing application program.

The point cloud data may be generated by physically scanning the structure of an object under analysis with a scanner (not shown) and stored in a file (i.e., the point cloud file) in the database 2, for the system 10 to access during operation. The scanner may be connected to the computing device or the database 2. The scanner may be a laser scanner or any other scanning device known in the art, capable of scanning 3D objects and generating corresponding 3D spatial point cloud data.

The memory 11 is configured to store relevant processing data for supporting operations of the system 10 and the processor 12. The memory 11 includes, but is not limited to, a memory, a hard disk, and an external memory. The memory 11 may be implemented by a volatile or nonvolatile memory chip including but not limited to a flash memory chip, a read-only memory chip, or a random access memory chip. The present disclosure is not limited to the example storage devices provided herein.

The processor 12 is the main operational core of the computing device 1 and is programmed to execute one or more operations of the computing device 1. The processor 12 in the illustrated embodiment may be implemented by a central processing unit (CPU), a microcontroller, or a data processor programmed with necessary firmware. The present disclosure is not limited to the computing examples provided herein.

In at least one embodiment, the memory 11 stores computable readable instructions for implementing the system 10, and the processor 12 is configured to read and execute computable readable instructions to implement the system 10.

The display 13 is configured to display representations of the object for a user to view and perform further processing.

FIG. 1 merely illustrates one implementation of the computing device 1, other implementations may include fewer or more components than illustrated, or have a different configuration of the various components in other embodiments.

The system 10 is operable to obtain or retrieve a point cloud file from the database 2 and to enable a user of computing device 1 to graphically process the point cloud data in the point cloud file. Specifically, the system 10 allows the user to flexibly select any region of any shape and size, so as to enable a user to accurately select any point cloud data for further data processing. In short, the system 10 enables the user to graphically eliminate (or remove) undesired point cloud data, the system 10 generates a more accurate profile image for the object. The point cloud file contains point cloud data (e.g., spatial coordinates) corresponding to an object, such as a mouse or other product.

The object (e.g., a mouse) under processing may correspond to one point cloud file (as in the instant disclosure) for simplicity. In practice, there may be one or more than one point cloud file associated with the object depending on the structural complexity of the object and/or object analysis requirements. The present disclosure does not limit the number of files that the system 10 can retrieve from the database 2 for the data processing of the object.

The system 10 includes an image forming module 101, a coordinate conversion module 102, a selection module 103, a determination module 104, and a marking module 105. The image forming module 101 is coupled to the coordinate conversion module 102. The coordinate conversion module 102 is coupled to the selection module 103. The selection module is coupled to the determination module 104. The determination module 104 is coupled to the marking module 105.

The image forming module 101 can retrieve the point cloud file corresponding to the object (e.g. a mouse) from the database 2, convert three-dimensional coordinate data into a plurality of graphical points, and graph each graphical point accordingly, to form a three-dimensional image. Specifically, the image forming module 101 retrieves and opens the point cloud file with the graphic processing system (e.g., the CAD system). In the illustrated embodiment, the point cloud file is a data file containing spatial coordinates representing the object, wherein each of the graphical points is formed from three spatial coordinates (e.g., three-dimensional coordinate) in the point cloud file. The image forming module 101 generates a three-dimensional image based on the three spatial coordinates associated with the graphical points. The three-dimensional image formed from graphical points is further presented on the display 13 of the computing device 1 for the user to view and edit.

The coordinate conversion module 102 can process graphical points and convert the graphical points from the world coordinate system (WCS) into the rectangular coordinate system (e.g., Cartesian coordinate system) according to the mathematical relationship. The world coordinate system or the global coordinate system is the coordinate system has the origin fixed at the datum mark in the real physical object model.

Below describes the conversion operation performed by the coordinate conversion module 102 for converting the graphical points from the world coordinate system into the rectangular coordinate system.

Firstly, the relationship between image coordinates (μ, ν) and rectangular coordinates (x, y) is given by the following equation (equation (1)),

$$[ \begin{matrix}μ \\ v \\ 1\end{matrix} ] = [ \begin{matrix}\frac{1}{{μ}_{x}} & - \frac{1}{{μ}_{x}} cot θ & {μ}_{0} \\ 0 & \frac{1}{{μ}_{y}} \frac{1}{sin θ} & {v}_{o} \\ 0 & 0 & 1\end{matrix} ] \cdot [ \begin{matrix}x \\ y \\ 1\end{matrix} ] \qquad ( 1 )$$

wherein, μ₀, ν₀ represent the image coordinates of O₁ in the image coordinate system of the graphic processing system; μₓ, ν_{y} represent projections of x- and y-coordinates onto μ and ν axes; θ represents an included angle between the μ and ν axes.

The world coordinate system consists of a reference origin point, an X_{W}-axis, a Y_{W}-axis, and a Z_{W}-axis. The relationship between the world coordinate system and the coordinate system in an image for a point P is given by the following equation (equation (2)),

$$[ \begin{matrix}{X}_{C} \\ {Y}_{C} \\ {Z}_{C} \\ 1\end{matrix} ] = [ \begin{matrix}\underline{R} & \underline{T} \\ {0}^{T} & 1\end{matrix} ] \cdot [ \begin{matrix}{X}_{W} \\ {Y}_{W} \\ {Z}_{W} \\ 1\end{matrix} ] = \underline{{M}_{1}} [ \begin{matrix}{X}_{W} \\ {Y}_{W} \\ {Z}_{W} \\ 1\end{matrix} ] \qquad ( 2 )$$

wherein [X_{C} Y_{C} Z_{C} 1]^{T} represent the homogeneous coordinate vector of point P in coordinate system of an image; [X_{W} Y_{W} Z_{W} 1]^{T} represent the homogeneous coordinate vector of point P in world coordinate system; R represents a 3 by 3 orthogonal matrix; T represents a translation vector [Tₓ T_{y} T_{Z}]^{T}; M₁ represents a 4 by 4 matrix,

$$[ \begin{matrix}\underline{R} & \underline{T} \\ {0}^{T} & 1\end{matrix} ] .$$

In general, matrices R and T are external parameters provided to the coordinate conversion module 102, and matrices R and T may be pre-stored in the memory 11. The three Euler angles of R are the derivation angle θ, the tilt angle, and the rotation angle φ. R may be represented in terms of Euler angles using this equation (equation (3)),

$$R = [ \begin{matrix}cos ϕ cos θ & sin ϕ cos θ & - sin θ \\ - sin ϕ cos φ + cos ϕ sin θ cos φ & cos ϕ cos φ + sin ϕ sin θ sin φ & cos θ sin φ \\ sin ϕ sin φ + cos ϕ sin θ cos φ & - cos ϕ cos φ + sin ϕ sin θ sin φ & cos θ sin φ\end{matrix} ] \qquad ( 3 )$$

wherein θ represents derivation angle; φ represents the tilt angle; co represents the rotation angle.

Next, the mapping relation between the world coordinate system and the rectangular coordinate system is given by the following equation (equation (4)),

$${Z}_{C} [ \begin{matrix}x \\ y \\ 1\end{matrix} ] = [ \begin{matrix}f & 0 & 0 & 0 \\ 0 & f & 0 & 0 \\ 0 & 0 & 1 & 0\end{matrix} ] \cdot [ \begin{matrix}{X}_{C} \\ {Y}_{C} \\ {Z}_{C} \\ 1\end{matrix} ] \qquad ( 4 )$$

wherein x represents the x-axis image coordinates of the point P and is computed by

$$\frac{{fX}_{C}}{{Z}_{C}} ;$$

y represents the y-axis image coordinates of the point P and is computed by

$${\frac{{fY}_{C}}{{Z}_{C}} ; [ \begin{matrix}{X}_{C} & {Y}_{C} & {Z}_{C} & 1\end{matrix} ]}^{T}$$

represents the spatial coordinate vector of the point P.

The coordinate conversion module 102 can convert the world coordinates associated with each graphical point of the three-dimensional image into corresponding rectangular coordinates to transform the three-dimensional image into a planar point cloud image.

Accordingly, the coordinate conversion module 10 converts the world coordinates of each graphical point into corresponding rectangular coordinates using equations (1) to (4), as depicted in the following equation (equation (5)),

$$\begin{matrix}{Z}_{C} [ \begin{matrix}u \\ v \\ 1\end{matrix} ] = [ \begin{matrix}\frac{1}{{μ}_{x}} & - \frac{1}{{μ}_{x}} cot θ & {μ}_{0} \\ 0 & \frac{1}{{μ}_{y}} \frac{1}{sin θ} & {v}_{o} \\ 0 & 0 & 1\end{matrix} ] \cdot [ \begin{matrix}f & 0 & 0 & 0 \\ 0 & f & 0 & 0 \\ 0 & 0 & 1 & 0\end{matrix} ] \cdot [ \begin{matrix}\underline{R} & \underline{T} \\ {0}^{T} & 1\end{matrix} ] \cdot [ \begin{matrix}{X}_{W} \\ {Y}_{W} \\ {Z}_{W} \\ 1\end{matrix} ] \\ = [ \begin{matrix}{f}_{x} & - {f}_{x} cot θ & {μ}_{0} & 0 \\ 0 & {f}_{y} \frac{1}{sin θ} & {v}_{0} & 0 \\ 0 & 0 & 1 & 0\end{matrix} ] \cdot [ \begin{matrix}\underline{R} & \underline{T} \\ {0}^{T} & 1\end{matrix} ] \cdot [ \begin{matrix}{X}_{W} \\ {Y}_{W} \\ {Z}_{W} \\ 1\end{matrix} ] \\ = \underline{{M}_{1} {M}_{2}} [ \begin{matrix}{X}_{W} \\ {Y}_{W} \\ {Z}_{W} \\ 1\end{matrix} ] = \underline{MX}\end{matrix} \qquad ( 5 )$$

wherein μ₀, ν₀ represent the image coordinates of O₁ in the image coordinates system of the graphic processing system; μₓ, ν_{y} represent projections of x- and y-coordinates onto μ and ν axes; θ represents the included angle between the μ and ν axes; [X_{C} Y_{C} Z_{C} 1]^{T} represents the homogeneous coordinates vector of point P in image coordinate system; [X_{W} Y_{W} Z_{W} 1]^{T} Represents the Homogeneous Coordinate Vector of Point P in world coordinate system; R represents a 3 by 3 orthogonal matrix; T represents a translation vector [Tₓ T_{y} T_{Z}]^{T}; M₁ represents a 4 by 4 matrix,

$$[ \begin{matrix}\underline{R} & \underline{T} \\ {0}^{T} & 1\end{matrix} ] .$$

After the coordinate conversion module 102 converts the world coordinates of each graphical point into rectangular coordinates, the coordinate conversion module 102 transforms the three-dimensional image into a planar point cloud image and graphs the planar point cloud image.

The selection module 103 can execute a polygon-shaped selection operation, and graph and form a polygon-shaped region in such a manner that the polygon-shaped region circumscribes the point cloud area selected. Specifically, the selection module 103 graphs the polygon-shaped region based on a point cloud area selected by a user.

In at least one embodiment, the selection module 103 executes the polygon-shaped selection operation based on the operation of the user. The polygon-shaped selection operation may be initiated by the user. The polygon-shaped selection operation includes forming a straight line extending from an edge of the point cloud area selected by the user and creating an anchor point as a starting point at an intersection between an edge of the point cloud area and the straight line. A closed-loop polygon-shaped region following the shape of point cloud area is thus formed.

The determination module 104 can obtain the coordinates corresponding to each set of graphical points associated with each side of the polygon-shaped region, and can graph a bounding box based on each set of graphical points associated with the polygon-shaped region. The determination module 104 further determines whether each of the graphical points lying inside the bounding box also lies inside the polygon-shaped region, so as to determine whether all the graphical points inside the polygonal-shaped region have been selected.

The marking module 105 can perform a marking process, to mark or highlight each of the graphical points determined to be lying within both the bounding box and the polygon-shaped region for further processing (e.g., removal processing). The marking module 105 does not mark any graphical point that lies inside the bounding box but outside the polygon-shaped region. In other words, the marking module 105 only marks the graphical points (i.e., the undesired noise points), that need to be further processed by viewing and performing elimination processing, thereby enabling the user to quickly and accurately remove undesired noise graphical points.

In at least one embodiment, the marking module 105 may be realized by a color-marking module, which color-marks each of the graphical points (i.e., the undesired noise points) determined to be lying within the polygon-shaped region, by changing the displayed color of each of the graphical points into a specific color. The displayed specific color may be a color different from that of the displayed color of the graphical points outside the bounding box and the polygon-shaped region, and may be selected by the user.

It is worth to mention that in one embodiment, the image forming module 101, the coordinate conversion module 102, the selection module 103, the determination module 104, and the marking module 105 may be implemented by programming one or more processing chips (e.g., a microprocessor or micro-controller) with necessary codes or instructions to implement corresponding algorithms, wherein the one or more processing chips are configured to communicably with the memory 11, the processor 12, and the display 13.

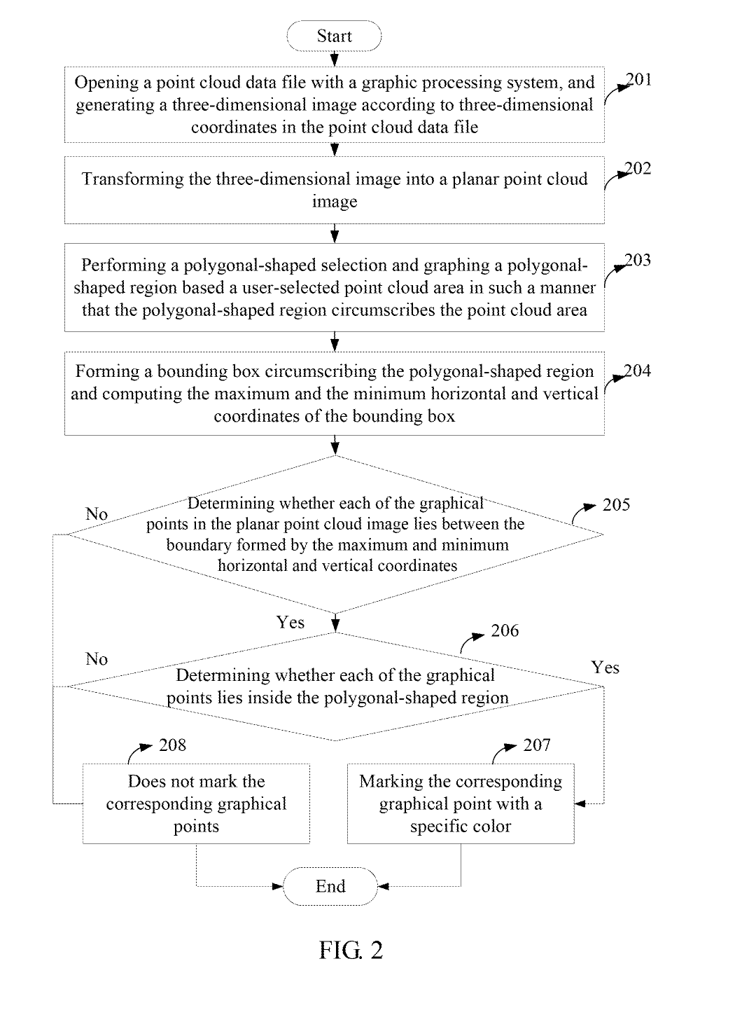

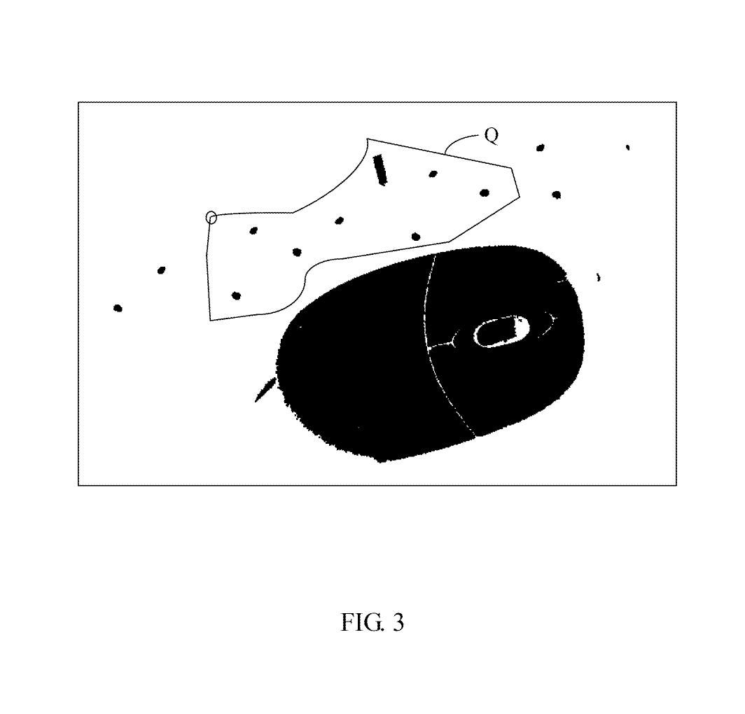

FIG. 2-FIG. 5 in conjunction with FIG. 1. FIG. 2 show a flowchart illustrating a point cloud data processing method provided in accordance with an exemplary embodiment of the present disclosure. The method depicted in FIG. 2 can be adopted by the system 10 operating on the computing device 1. FIG. 3-FIG. 5 are diagrammatic views respectively illustrating the operation of the point cloud data processing method provided by an exemplary embodiment of the present disclosure.

The example method shown in FIG. 2 is provided by way of example, as there are a variety of ways to carry out the method. The method enables the user to quickly and accurately identify undesired noise graphical points and eliminate these graphical points such that a more precise product image can be generated for further processing. FIG. 3-FIG. 5 merely serve as an illustration for elaborating the point cloud data processing method of FIG. 2, and the present disclosure is not limited thereto.

Furthermore, the illustrated order of blocks is illustrative only and the order of the blocks can change. Additional blocks can be added or fewer blocks may be utilized, without departing from this disclosure.

In at least one embodiment, the memory 11 is configured to store the computer readable instruction data corresponding to the point cloud data processing method depicted in FIG. 2 and the processor 12 is configured to execute the computer readable instruction data stored in the memory 11 to execute the point cloud data processing method.

At block 201, the image forming module 101 retrieves the point cloud file corresponding to the object (e.g. a mouse) from the database 2, and opens the point cloud file with the graphic processing system (e.g., the CAD system). The graphic processing system (e.g., the CAD system may be initiated by a user. The image forming module 101 at block 201 also converts three-dimensional coordinate data into graphical points, and graphs each graphical point accordingly to generate a three-dimensional image shown on a display window of the graphic processing system (e.g., the CAD system). The content of the display window of the graphic processing system (e.g., the CAD system) is displayed or shown to the user on the display 13 of the computing device 1.

In the instant embodiment, the image forming module 101 may obtain the point cloud file by performing the file import operation. The point cloud file as described previously is a file containing point cloud data corresponding to the object as measured in a coordinate system (e.g., a Cartesian coordinate system). The point cloud data recorded in the point cloud file in the instant embodiment are spatial coordinate set associated with each graphical point in a 3D point cloud space on a one-one basis. The image forming module 101 automatically graphs graphical points associated with the three-dimensional coordinate of the object (e.g., the mouse) onto the display window of the graphic processing system (e.g., the CAD system). The image forming module 101 may further store the graphical points converted in the memory 11.

At block 202, the coordinate conversion module 102 converts the world coordinate of each graphical point into the corresponding rectangular coordinate based on the relationship between the world coordinate system and the rectangular coordinate system, so as to transform the three-dimensional image into a planar point cloud image. The coordinate conversion module 102 further graphs the planar point cloud image (e.g., FIG. 3) onto the display window of the graphic processing system (e.g., the CAD system) according to the rectangular coordinates.

More specifically, the coordinate conversion module 102 can convert the world coordinate of each graphical point into the corresponding rectangular coordinate using above described equations (1) to (4), and transform the three-dimensional image into the planar point cloud image. The graphical points associated with planar point cloud image may be also stored in the memory 11.

At block 203, the selection module 103 executes a polygonal-shape selection operation based on a user's operation. During the execution of the polygonal-shape selection operation, the selection module 103 graphs a polygonal-shaped region based on the shape of a point clod area selected by the user via a mouse. The selection module 103 graphs a polygonal-shaped region similar to the shape of the point cloud area selected with a polygonal selection tool (e.g., polygonal lasso selection tool) in such a manner that the polygonal-shaped region circumscribes the point cloud area selected.

In at least one embodiment, during the execution of the polygonal-shape selection operation, the selection module 103 graphs a straight-line extending from an edge (or a side) of the point cloud area selected by the user using the mouse (e.g., a left click) to create an anchor point (e.g., a circular point). The anchor point is formed as a starting point at an intersection between an edge of the point cloud area, and the straight-line extended from the edge of the point cloud area. When the anchor point is created, the selection module 103 may form a closed-loop polygonal-shaped region following the shape of point cloud area as the user operates the mouse (e.g., another mouse click operation). In the instant embodiment, the polygonal selection enables the user to freely select a region of any shape and any size for selecting desired any graphical points or graphical points in a specific region for further operation without adding undesired graphical points. As shown in FIG. 3, the polygonal-shaped region Q is the selection frame created by the selection module 103 based on the user operation. The region encompassed by the polygonal-shaped region Q is the region containing graphical points selected for further processing.

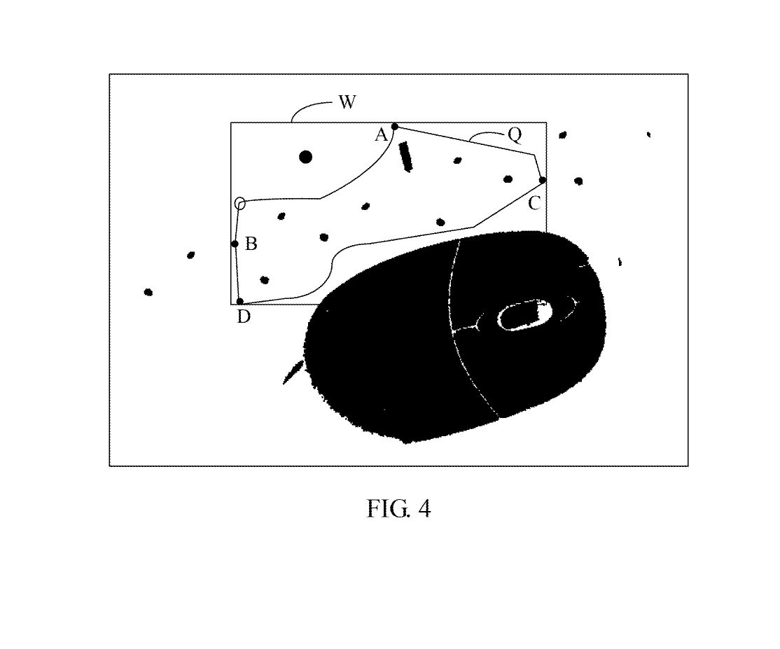

At block 204, the determination module 104 obtains the coordinates corresponding to each set of graphical points associated with each side of the polygonal-shaped region, and obtain a bounding box circumscribing all the graphical points. The determination module 104 graphs the bounding box based on each set of graphical points associated with the polygonal-shaped region correspondingly on the display window of the graphic processing system. The determination module 104 calculates the maximum and the minimum horizontal coordinates (i.e., x-axis coordinates) and vertical coordinates (i.e., y-axis coordinates) of the bounding box. As shown in FIG. 4, a bounding box W is the smallest rectangular bounding box containing all the graphical points (e.g., undesired noise graphical points) that needed to be further processed.

More specifically, the determination module 104 obtains the bounding box W by first searching for the maximum and the minimum coordinates of the polygonal-shaped region Q along both X- and Y-directions by comparing coordinates of the polygonal-shaped region Q. Based on the example depicted in FIG. 4, the maximum and minimum x-axis coordinates are found to be point B and point C, respectively, and the maximum and minimum y-axis coordinates are found to be point A and point D, respectively. The determination module 104 determines the size of the bounding box W based on the maximum and minimum coordinates of the polygonal-shaped region Q along both X- and Y-directions.

At block 205, the determination module 104 then determines whether the horizontal and vertical coordinates associated with each graphical point on the planar point cloud image lies between the maximum and minimum coordinates of the bound box W to determine whether the respective graphical point lies bounding the bounding box W. If the determination module 104 determines that the graphical point lies inside the bounding box W, executes block 206, otherwise, i.e., the graphical point lies outside the bounding box W, executes block 208.

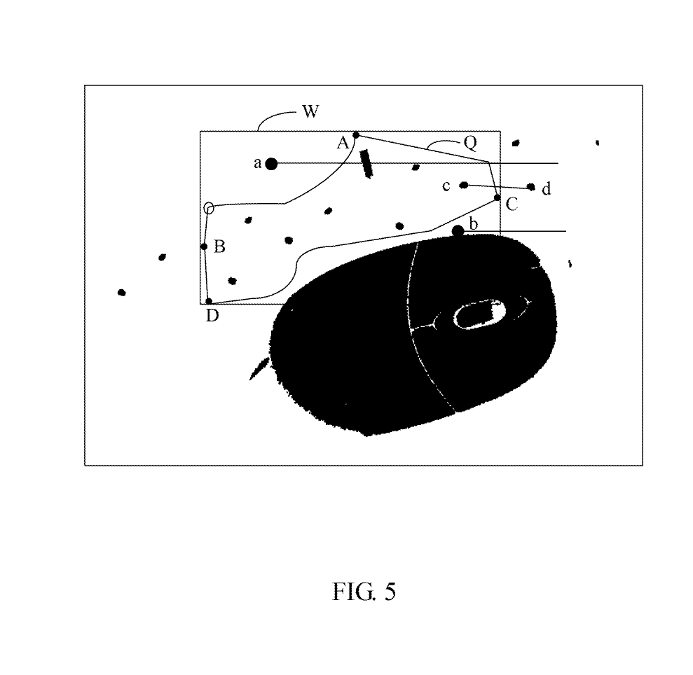

In the instant embodiment, the determination module 104 compares each of the graphical points in the planar point cloud image with the maximum and minimum coordinates of the bound box W. If the coordinate of the respective graphical point (i.e., both the x- and y-coordinates) lies within the range formed by the maximum and minimum coordinates of the bound box W, the determination module 104 determines that the graphical point lies inside the bounding box W. On the other hand, when any of the x-coordinate and y-coordinate lies outside the range formed by the maximum and the minimum coordinates of the bound box W, the determination module 104 determines that the graphical point lies outside the bounding box W. As shown in FIG. 5, points a, b, and c are determined to be lying inside the bounding box W while point d lies outside the bounding box W.

It is worth to mention that in practice, the bounding box W may take any geometric shape, so long as the bound box W created may be compared with the polygonal-shaped region Q and determined whether the graphical points desired for further processing are all selected.

At block 206, the determination module 104 determines and obtains all the graphical points lying inside the bounding box W. The determination module 104 further determines whether all the graphical points lying inside the bounding box W at same time lies inside the polygonal-shaped region Q. If the respective graphical point is determined to be both lying inside the bounding box W and the polygonal-shaped region Q, executes block 207. On the other hand, if the respective graphical point is determined to be lying outside the polygonal-shaped region Q, executes block 208.

In the instant embodiment, the determination module 104 obtains all the graphical points inside the bounding box, and graphs a ray stating at the position of the respective graphical point and extends along a positive x-axis direction (e.g., in a right direction) in the rectangular coordinate system. Please noted that straight-lines are drawn from graphical points inside the bounding box W and extended across the polygonal-shaped region Q toward the furthermost side of the bounding box W. The determination module 104 then determines the number of intersection points between the straight-line and the edge of the polygonal-shaped region Q to determine whether the corresponding graphical point lies inside the polygonal-shaped region Q, i.e., whether the corresponding graphical point should be selected. Specifically, if the determination module 104 determines that the number of intersection points between the straight-line and the edge of the polygonal-shaped region Q is computed to be an odd number, the determination module 104 determines that the graphical point lies inside the polygonal-shaped region Q and the graphical point should be selected.

As shown in FIG. 5, there is one intersection point between the straight-line drawn from point c and an edge of the polygonal-shaped region Q, thus the determination module 104 determines that point c should be selected. And if the number of the intersection points between the straight line drawn from a particular graphical point and the edge of the polygonal-shaped region Q is computed to be 0 or an even number, the determination module 104 determines that the graphical point lies outside the polygonal-shaped region Q, i.e., the respective graphical point should not be selected. As shown in FIG. 5, the number of interaction points between the corresponding straight-line drawn respectively from points a and b and the polygonal-shaped region Q are two and zero, respectively, the determination module 104 determines that point a and point b lie outside the polygonal-shaped region Q. In other words, point a and point b are not the graphical point to be selected for further processed.

At block 207, the marking module 105 performs a marking process and marks each of the graphical points determined lying in both the bounding box W and the polygonal-shaped region for further processing (e.g., removal processing).

In the instant embodiment, the marking module 105 color-marks each of the graphical points selected into a specific color. The specific color includes but not limited to red, yellow, green or any other color distinct from the display color of the unselect graphical points. Specifically, the marking module 105 is a color marking module and transforms the graphical points selected (i.e., lies inside both the bounding box W and the polygonal-shaped region Q) from the initial color (e.g., black) into red, by changing the graphical color value corresponding to the black color of the corresponding graphical point into the graphical color value corresponding to the red color.

At block 208, the marking module 105 does not perform any marking process to the corresponding graphical points, i.e., does not mark the corresponding graphical points, that lies outside the bounding box W, In other words, the marking module 105 does not mark any graphical points that lies inside the bound box but outside the polygonal-shaped region.

In one embodiment, the graphical points marked with the specific color are removed from the planar point cloud image, so as to eliminate the undesired noise graphical points for subsequent image processing operations.

The method described can be adopted for graphic processing system for graphically processing point cloud data include but is not limited to CAD graphic processing system, computer aid verification (CAV) system, and three-dimensional scanner system (such as Power Scan).

Additionally, the present disclosure also discloses a non-transitory computer-readable medium for storing the computer executable program codes of the method for processing point cloud data depicted in FIG. 2. The non-transitory computer-readable media may be a floppy disk, a hard disk, a compact disk (CD), a flash drive, a magnetic tape, accessible online storage database or any type of storage medium having similar functionality known to those skilled in the art. The codes can be read and executed by the processor 12 of the computing device 1.

To sum, the present disclosure provided a system and a method that enable a user to accurately select any graphical points extracted from point cloud data to process by enabling the user to flexibly select any regions of any shapes and any sizes in a point cloud image, and graphically eliminating noise or undesired graphical points in the point cloud image and produce accurate profile image for a product scanned.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A point cloud data processing system communicatively coupled to a database and a graphic processing system, the system comprising:
an image forming module configured to obtain a point cloud file from the database, convert three-dimensional coordinates recorded in the point cloud file into a plurality of graphical points, and generate a three-dimensional image using the graphic processing system according to the graphical points;
a coordinate conversion module coupled to the image forming module, the coordinate conversion module configured to operatively convert a world coordinate associated with each graphical point in the three-dimensional image into a corresponding rectangular coordinate to transform the three-dimensional image into a planar point cloud image;
a selection module coupled to the coordinate conversion module, the selection module configured to perform a polygonal-shape selection operation and form a polygonal-shaped region based on a point cloud area selected in such a manner that the polygonal-shaped region circumscribes the point cloud area selected on the graphic processing system; and
a determination module coupled to the selection module, the determination module configured to generate a bounding box based on each set of graphical points associated with the each side of the polygonal-shaped region, and to determine whether each of the graphical points lies inside the bounding box also lies inside the polygonal-shaped region;
wherein each graphical points in the bounding box determined lying inside the polygonal-shaped region are further process with a marking operation.

2. The point cloud data processing system according to claim 1, further comprising:
a color-marking module coupled to the determining module, and the color marking module configured to mark each of the graphical points determined lying inside the polygonal-shaped region by changing the display color of each of the graphical points into a specific color.

3. The point cloud data processing system according to claim 2, wherein any graphical points that lies inside the bound box but is outside the polygonal-shaped region are not marked.

4. The point cloud data processing system according to claim 1, wherein the determination module compute the maximum and the minimum horizontal and vertical coordinates of the bounding box; and determine whether each of the graphical points in the planar point cloud image lies between the boundary formed by the maximum and the minimum horizontal and vertical coordinates, so as to determine whether each of the graphical points lying the bounding box also lies inside the polygonal-shaped region.

5. The point cloud data processing system according to claim 1, wherein the determination module determines whether each of the graphical points in the bounding box lies inside the polygonal-shaped region by:
obtaining graphical points inside the bounding box;
forming a first straight-line extending along a first axis direction stating at the position of the respective graphical point;
computing the number of intersecting points between the first straight-line and an edge of the polygonal-shaped region;
determining whether the graphical point lies inside the polygonal-shaped region based on the number of intersecting points between the straight-line and the polygonal-shaped region; and
when the number of intersecting points between the first straight-line and the polygonal-shaped region is an odd number, determined that the respective graphical point lies inside the polygonal-shaped region.

6. The point cloud data processing system according to claim 1, wherein the polygonal-shape selection operation is initiated by a user, and the selection module performs the polygonal-shape selection operation by forming a second straight-line extending from an edge of the point cloud area, creating an anchor point as a starting point at an intersection between an edge of the point cloud area and the second straight-line, and forming a closed-loop polygonal-shaped region following the outline of point cloud area.

7. A point cloud data processing method implemented by a system for point cloud data processing, the system being communicate coupled to a database and a graphic processing system, the method comprising:
obtaining, by the system for point cloud data processing, a point cloud data file from the database;
generating, by the system for point cloud data processing, a three-dimensional image using the graphic processing system according to a plurality of graphical points recorded in the point cloud data file;
transforming, by the system for point cloud data processing, the three-dimensional image into a planar point cloud image;
performing by the system for point cloud data processing, a polygonal-shape selection operation;
forming, by the system for point cloud data processing, a polygonal-shaped region based on a point cloud area selected in such a manner that the polygonal-shaped region circumscribes the point cloud area selected;
forming, by the system for point cloud data processing, a bounding box based on the outline of the polygonal-shaped region;
determining, by the system for point cloud data processing, whether each of the graphical points that lies in the bounding box also lies inside the polygonal-shaped region; and
marking, by the system for point cloud data processing, graphical points that are determined to lie inside both the bounding box and the polygonal-shaped region.

8. The method according to claim 7, wherein the operation of marking each graphical point according to the determination result further comprising: marking, by the system for point cloud data processing, each of the graphical points determined both lying inside the bounding box and the polygonal-shaped region by change the display color of the respective graphical point into a specific color.

9. The method according to claim 8, further comprising:
removing, by the system for point cloud data processing, the graphical points marked with the specific color from the planar point cloud image.

10. The method according to claim 7, comprising:
converting, by the system for point cloud data processing, three-dimensional coordinates recorded in the point cloud file into a plurality of graphical points; and
graphing, by the system for point cloud data processing, each graphical point and form the three-dimensional image on the graphic processing system.

11. The method according to claim 7, wherein the operation of transforming the three-dimensional image into the planar point cloud image comprises converting, by the system for point cloud data processing, a world coordinate associated with each graphical point in the three-dimensional image into a corresponding rectangular coordinate.

12. The method according to claim 7, wherein the operation of graphing the bounding box further comprising:
obtaining, by the system for point cloud data processing, coordinates corresponding to the outline of the polygonal-shaped region, and graphing the bounding box according to the coordinates obtained.

13. The method according to claim 7, wherein the operation of determining whether each of the graphical points that lies inside the bounding box also lies inside the polygonal-shaped region further comprising:
computing, by the system for point cloud data processing, the maximum and the minimum horizontal and vertical coordinates associated with the bounding box;
determining, by the system for point cloud data processing, whether each of the graphical points in the planar point cloud image lies between the boundary formed by the maximum and the minimum horizontal and vertical coordinates; and
determining, by the system for point cloud data processing, that the respective graphical point lies inside both the bounding box and the polygonal-shaped region when the system for point cloud data processing determined that the graphical points in the planar point cloud image lies between the boundary formed by the maximum and the minimum horizontal and vertical coordinate.

14. The method according to claim 7, wherein the operation of determining whether each of the graphical points that lies inside the bounding box also lies inside the polygonal-shaped region further comprising:
obtaining, by the system for point cloud data processing, all graphical points inside the bounding box;
forming, by the system for point cloud data processing, a first straight-line along a first axis direction in the rectangular coordinate system stating at the position of the respective graphical point;
computing, by the system for point cloud data processing, the number of intersecting points between the first straight-line and an edge of the polygonal-shaped region;
determining, by the system for point cloud data processing, whether the graphical point lies inside the polygonal-shaped region based on the number of intersecting point between the first straight-line and the polygonal-shaped region; and
when the number of intersecting point between the first straight-line and the polygonal-shaped region is an odd number, determined that the respective graphical point lies inside the polygonal-shaped region.

15. The method according to claim 7, wherein the operation of graphing the polygonal-shape selection further comprising:
forming, by the system for point cloud data processing, a second straight-line extending from an edge of the point cloud area according to an operation of a user;
creating, by the system for point cloud data processing, an anchor point as a starting point at an intersection between the edge of the point cloud area and the second straight line; and
forming, by the system for point cloud data processing, a closed-loop polygonal-shaped region following the shape of point cloud area.

16. A non-transitory computer-readable storage medium storing a set of instructions, when executed by at least one processor of a computing device comprising a graphic processing system, causes the at least one processor to:
obtain a point cloud data file from a database communicatively coupled to the computing device;
generating a three-dimensional image using a graphic processing system according to a plurality of graphical points recorded in the point cloud data file;
transform the three-dimensional image into a planar point cloud image;
perform a polygonal-shaped selection operation;
form a polygonal-shaped region based a point cloud area selected in such a manner that the polygonal-shaped region circumscribes the point cloud area selected;
form a bounding box based on the outline of the polygonal-shaped region;
determining whether each of the graphical points that lies in the bounding box also lies inside the polygonal-shaped region; and
mark graphical points that are determined to lie inside both the bounding box and the polygonal-shaped region.

17. The non-transitory computer-readable storage medium according to claim 16, wherein the operation of marking each graphical points according to the determination result comprises:
mark each of the graphical points determined both lying inside the bounding box and the polygonal-shaped region by change the display color of the respective graphical point into a specific color.

18. The non-transitory computer-readable storage medium according to claim 16, further comprising:
removing the graphical points marked with the specific color from the planar point cloud image.
